(19) United States
(12) Patent Application Publication
(10) Pub. No.: US 2013/0238390 A1
(43) Pub. Date: Sep. 12, 2013

(54) INFORMING SALES STRATEGIES USING SOCIAL NETWORK EVENT DETECTION-BASED ANALYTICS

(71) Applicants: Rajaraman Hariharan, Bangalore (IN); Ramakrishnan Kannan, Yorktown Heights, NY (US); Karthik Subbian, Yorktown Heights, NY (US); Laura Wynter, Yorktown Heights, NY (US)

(72) Inventors: Rajaraman Hariharan, Bangalore (IN); Ramakrishnan Kannan, Yorktown Heights, NY (US); Karthik Subbian, Yorktown Heights, NY (US); Laura Wynter, Yorktown Heights, NY (US)

(73) Assignee: International Business Machines Corporation, Armonk, NY (US)

(21) Appl. No.: 13/414,082

(22) Filed: Mar. 7, 2012

(51) Int. Cl. G06Q 30/02

(52) U.S. Cl. 705/7.29

(57) ABSTRACT

A method of informing sales strategies using a social network includes receiving an input from an organization, wherein the input comprises information relating to an item for sale, extracting sales data from a first database, event history data from a second database, and action history data from a third database, wherein the sales data represents past sales of the item, the event history data represents past events, and the action history data represents past actions taken by the organization, establishing a connection with the social network via a communication network, monitoring a real-time data stream via the connection to the social network for mentions relating to the item, and generating an action recommendation relating to the item based on the sales data, event history data, action history data, and mentions relating to the item.

### BACKGROUND

1. Technical Field

The present disclosure relates to a system and method for informing sales strategies using social network event detection-based analytics.

2. Discussion of Related Art

The occurrence of major events may influence a buyer's behavior. For example, events such as weather changes, natural disasters, political campaigns, and social events such as the Olympic games may have a direct impact on a buyer's purchasing decisions. Large retail chains such as WALMART, MACY'S, and KMART may utilize information related to major events to manage their inventory, pricing, and other retail operations more effectively.

In addition to major events, smaller events such as rallies, parades, and local elections, as well as more subtle occurrences such as changes in the perception of a product brand, may also influence retail sales at certain times in certain places. Although smaller retailers may be able to leverage this local information to adapt their sales tactics in an effort to increase sales, large retail chains have generally been unable to effectively utilize such local information.

The increasing popularity and use of social networks such as FACEBOOK and TWITTER, as well as other Internet websites, allows for easier access to information pertaining to smaller local events. These social networks present an opportunity to large retailers, wholesalers, distributors, and suppliers to utilize local information to increase sales.

### BRIEF SUMMARY

According to an exemplary embodiment of the present disclosure, a method of informing sales strategies using a social network includes receiving an input from an organization, wherein the input comprises information relating to an item for sale, extracting sales data from a first database, event history data from a second database, and action history data from a third database, wherein the sales data represents past sales of the item, the event history data represents past events, and the action history data represents past actions taken by the organization, establishing a connection with the social network via a communication network, monitoring a real-time data stream via the connection to the social network for mentions relating to the item, and generating an action recommendation relating to the item based on the sales data, event history data, action history data, and mentions relating to the item.

According to an exemplary embodiment of the present disclosure, a method of generating a stream of data related to an item set from a social network includes generating a plurality of keywords relating to the item set, establishing a connection with a social network via a communication network, generating a list of seed users from the social network based on the plurality of keywords, generating a list of secondary users related to the seed users, monitoring messages sent from and received by the seed users and the secondary users, extracting messages from the monitored messages, wherein the extracted messages include at least one of the plurality of keywords, and generating the stream of data related to the item based on the extracted messages.

According to an exemplary embodiment of the present disclosure, a system for informing sales strategies using a social network includes a network adapter configured to establish a connection to a social network and an organization via a communication network, and receive input from the organization comprising information relating to an item for sale, a first database comprising sales data representing past sales of an item, a second database comprising event history data representing past events, a third database comprising action history data representing past actions taken by the organization, and a processor configured to monitor a real-time data stream via the connection to the social network for mentions relating to the item, and generate an action recommendation relating to the item based on the sales data, event history data, action history data, and mentions relating to the item.

### BRIEF DESCRIPTION OF THE SEVERAL VIEWS OF THE DRAWINGS

Preferred embodiments of the present disclosure will be described below in more detail, with reference to the accompanying drawings:

FIG. 1A shows an overview of a calibration phase of a social network event detection-based analytics system and method, according to an exemplary embodiment of the present disclosure.

FIG. 1B shows an overview of an event detection phase of a social network event detection-based analytics system and method, according to an exemplary embodiment of the present disclosure.

FIG. 2A is a computer system for implementing a method of informing sales strategies based on social network event detection-based analytics, according to an exemplary embodiment of the present disclosure.

FIG. 2B shows an overview of a social network event detection-based analytics system, according to an exemplary embodiment of the present disclosure.

FIG. 3 shows an exemplary item ontology tree, according to an exemplary embodiment of the present disclosure.

FIG. 4 shows an exemplary mapping table related to the item ontology tree of FIG. 3, according to an exemplary embodiment of the present disclosure.

FIG. 5 shows exemplary mappings assigned to the item ontology tree of FIG. 3 based on the mapping table of FIG. 4, according to an exemplary embodiment of the present disclosure.

FIG. 6 is a flowchart illustrating an event detection phase of a method of informing sales strategies based on social network event detection-based analytics, according to an exemplary embodiment of the present disclosure.

### DETAILED DESCRIPTION

Exemplary embodiments of the present disclosure described herein involve assessing the impact of previous events on past sales, determining actions available to a retailer to increase sales, and detecting events affecting sales in real-time using social networks. In the exemplary embodiments described herein, social network event detection-based analytics are described as being utilized by a retailer to increase sales, however the present disclosure is not limited to use by retailers. For example, any organization involved in the sale and distribution of products, for example, wholesalers or manufacturers, may utilize the social network event detection-based analytics of the present disclosure.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Exemplary embodiments of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be, stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

According to an exemplary embodiment of the present disclosure, a social network event detection-based analytics method may include a calibration phase and an event detection phase. The calibration phase may be implemented prior to the event detection phase, simultaneously with the event detection phase, or may alternate with the event detection phase.

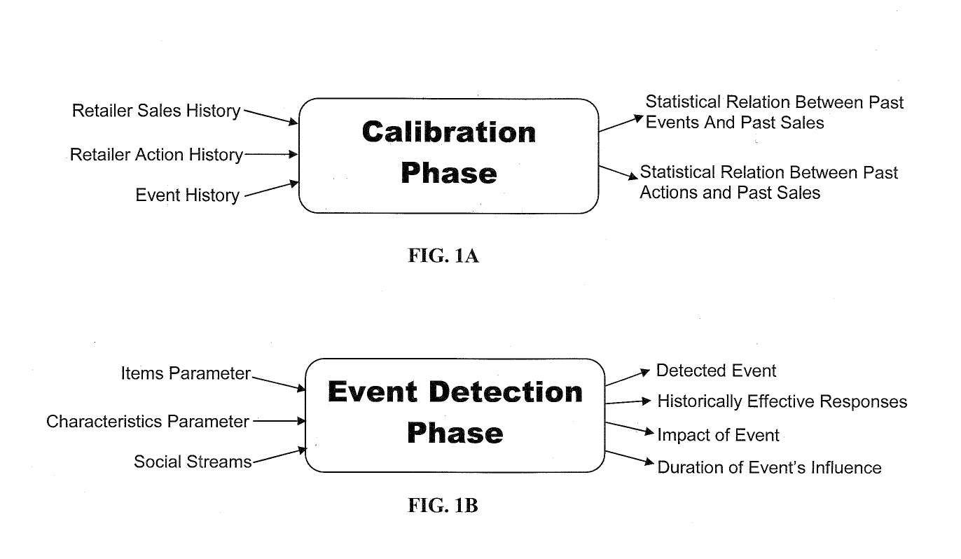

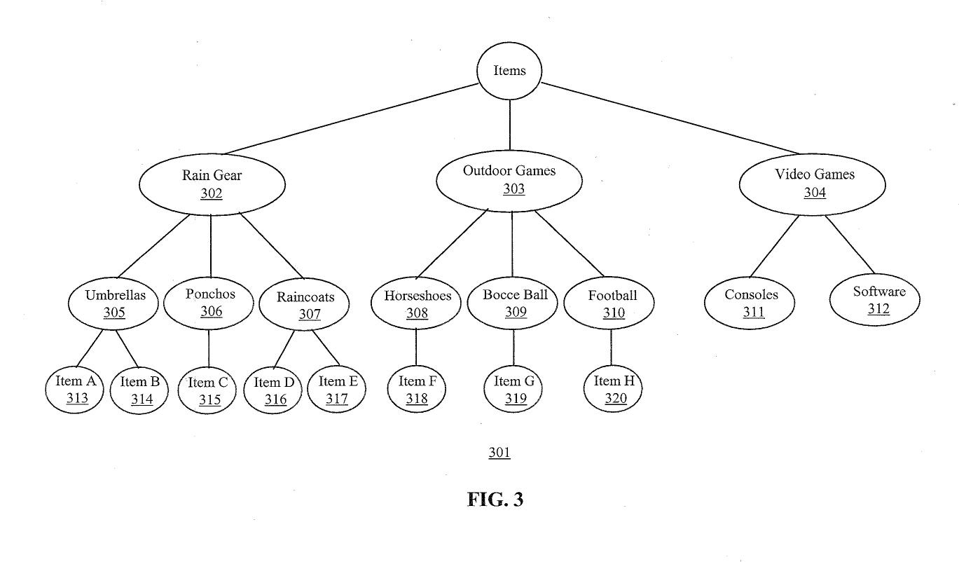

In the calibration phase, retailer sales history, retailer action history, and event history may be analyzed to determine a statistical relationship between past events and past sales, and a statistical relationship between past retailer actions and past sales, as shown in FIG. 1A. The calibration phase is described in more detail below with reference to FIGS. 3-5.

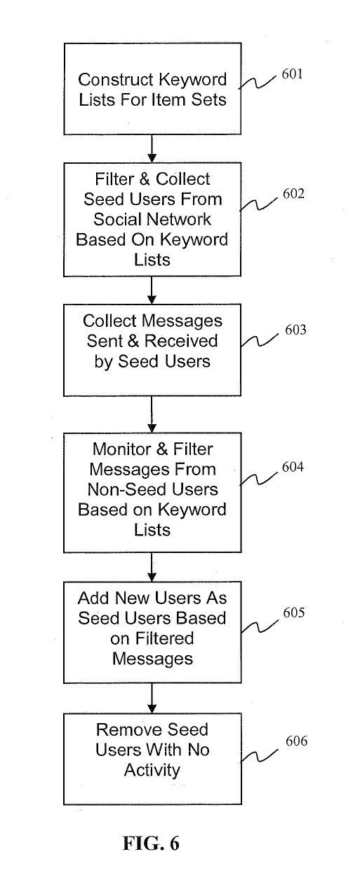

In the event detection phase, the social network event detection-based analytics system may dynamically determine ongoing or upcoming events that are relevant to retailers subscribed to the system. In the event detection phase, parameters relating to items sold by the retailer and characteristics of the retailer (e.g., store location, hours of operation), and social streams from social networks or websites may be utilized to detect the occurrence of an event, determine the impact of the event related to items sold by the retailer, determine historically effective responses to the event, and determine the duration of the event's influence, as shown in FIG. 1B. Items sold by the retailer may be categorized using an item ontology, as shown in FIG. 3. The parameters relating to characteristics of the retailer may include, for example, the retailer's store location, the hours of operation of the store location, and the weather at the store location. Social streams include information obtained by monitoring social networks and/or websites. For example, text mining, social network analysis, and website analysis may be utilized to detect opinion trends that are relevant for retailers. An opinion trend indicating whether a product is in high or low demand may be used by a retailer to adjust a sales tactic. For example, a retailer may increase the price of a product that is currently in high demand, increase advertising efforts for products anticipated to be in high demand as the result of mentions in a social stream, for example, mentions of an upcoming event, or adjust the layout of its store so that certain products are more visible at different times in response to the mentions of the upcoming event. Opinion trends may be based on mentions, including conversations between users on social networks and websites, comments on events or products made by users on social networks or websites, etc. The event detection phase is described in more detail below with reference to FIG. 6.

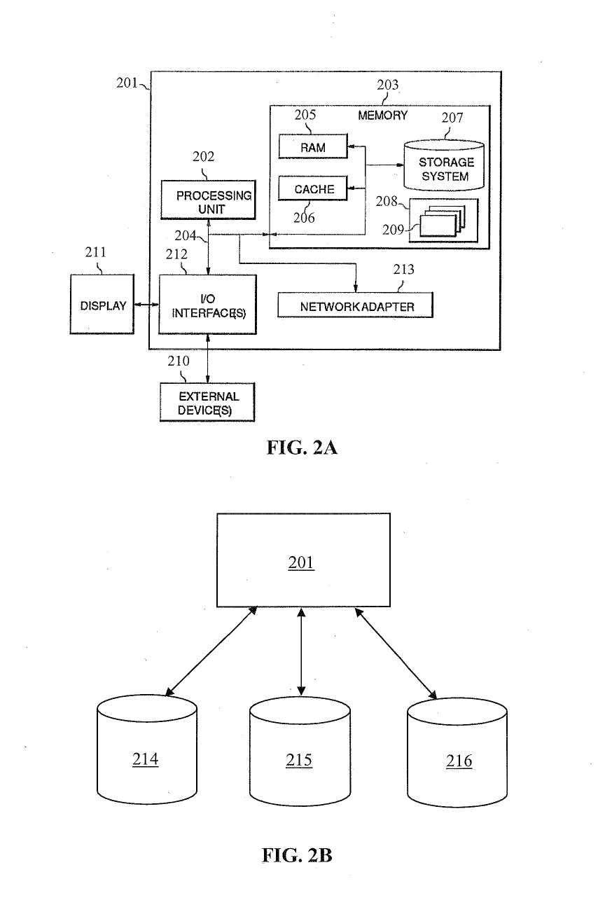

FIG. 2A shows the social network event detection-based analytics system 201, according to an exemplary embodiment.

The social network event detection-based analytics system 201 may be a general purpose or special purpose computing system. For example, the system 201 may be, but is not limited to, a personal computer system or a server computer system. The components of the system 201 may include, but are not limited to, one or more processors or processing units 202, a system memory 203, and a bus 204 that couples various system components including system memory 203 to processor 202. The bus 204 represents one or more of any of several types of bus structures, including a memory bus or memory controller, a peripheral bus, an accelerated graphics port, and a processor or local bus using any of a variety of bus architectures. By way of example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The social network event detection-based analytics system 201 may include a variety of computer system readable media. Such media may be any available media that is accessible by the system 201, and it includes both volatile and non-volatile media, removable and non-removable media. The system memory 203 may include computer system readable media in the form of volatile memory, such as random access memory (RAM) 205 and/or cache memory 206. The system 201 may further include other removable/non-removable, volatile/non-volatile computer system storage media. By way of example, storage system 207 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 204 by one or more data media interfaces. The system memory 203 may include at least one program product having a set (e.g., at least one) of program modules that are configured to carry out the functions of embodiments of the invention. The memory 203 may also include a relational database for storing structured data.

A computer program 208, having one or more program modules 209, may be stored in memory 203, as well as an operating system, one or more application programs, other program modules, and program data. Each of the operating system, one or more application programs, other program modules, and program data or some combination thereof, may include an implementation of a networking environment. The program modules 209 may carry out the functions and/or methodologies of embodiments of the invention as described herein.

The social network event detection-based analytics system 201 may also communicate with one or more external devices 210 such as a keyboard, a pointing device, or a display 211, one or more devices that enable a user to interact with the system 201, and/or any devices (e.g., network card, modem, etc.) that enable the system 201 to communicate with one or more other computing devices. Such communication can occur via Input/Output (I/O) interfaces 212. The system 201 may communicate with one or more networks such as a local area network (LAN), a general wide area network (WAN), and/or a public network (e.g., the Internet) via network adapter 213. As depicted, network adapter 213 communicates with the other components of the system 201 via bus 204. It should be understood that although not shown, other hardware and/or software components could be used in conjunction with social network event detection-based analytics system 201. Examples, include, but are not limited to, microcode, device drivers, redundant processing units, external disk drive arrays, RAID systems, tape drives, and data archival storage systems, etc.

In the calibration phase, the social network event detection-based analytics system 201 may communicate with a database to determine the impact past events have historically had on past sales. A list of keywords that represents a group of related products may be identified based on one or more product parameters. Product parameters may include, for example, the item type, item use, item price, the intended demographic of the item, etc. Weights may be used with different parameters to indicate an importance of each parameter relative to other parameters. In an exemplary embodiment, sales history data may be stored in a sales history database 214, event history data may be stored in an event history database 215, and retailer action history data may be stored in a retailer action history database 216. The sales history database 214 may include sales history of a single retailer or a group of retailers. Sales data corresponding to a single retailer indicates the impact past events have had on sales for that specific retailer, and sales data corresponding to a group of retailers indicates the impact past events have had on sales of the retailers referenced in the sales history database 214 as a whole.

Sales data from the sales history database 214 and event history data from the event history database 215 may be cross-referenced to determine the impact past events have had on past sales. Cross-referencing the sales data and event history data results in the determination of a statistical relationship between the occurrence of events and their effect on sales (e.g., in the past, event A has resulted in an increase in sales of a product, and event B has resulted in a decrease in sales of a product).

The retailer action history database 216 may be cross-referenced with the sales history data stored in the sales history database 214 to determine a statistical relationship between actions taken by a retailer and their effects on sale (e.g., the action of moving an item to a display at the front of the retailer's store previously resulted in increased sales).

In an exemplary embodiment, the sales history database 214, the event history database 215, and the retailer action history database 216 may be combined into a single database. One or more of the databases 214, 215 and 216 may be part of the social network event detection-based analytics system 201, or located remote from the system 201.

A retailer may provide an item ontology tree 301 as input to the system during the calibration phase. The item ontology formally represents knowledge as a set of concepts within a domain, and the relationships between those concepts. More particularly, the item ontology tree 301 includes a categorical listing of items sold by the retailer. FIG. 3 shows an example of an item ontology tree 301. The item ontology tree 301 may include any number of items offered by the retailer.

The item ontology tree 301 includes nodes and subnodes corresponding to categories and items. For example, in FIG. 3, a node 302 corresponding to a rain gear category includes a first subnode 305 corresponding to umbrellas, a second subnode 306 corresponding to ponchos, and a third subnode 307 corresponding to raincoats. The subnode 305 corresponding to umbrellas includes subnodes 313 and 314 corresponding to items A and B, respectively. The subnode 306 corresponding to ponchos includes subnode 315 corresponding to item C. The subnode 307 corresponding to raincoats includes subnodes 316 and 317 corresponding to items D and E, respectively. The item ontology tree 301 in FIG. 3 also includes a node 303 corresponding to an outdoor games category, which includes subnodes 308, 309 and 310 corresponding to horseshoes, bocce ball, and football, respectively. The subnode 308 corresponding to horseshoes includes subnode 318 corresponding to item F, the subnode 309 corresponding to bocce ball includes subnode 319 corresponding to item G, and the subnode 310 corresponding to football includes subnode 320 corresponding to item H. The item ontology tree 301 in FIG. 3 also includes a node 304 corresponding to video games, which includes a subnode 311 corresponding to video game consoles and a subnode 312 corresponding to video game software.

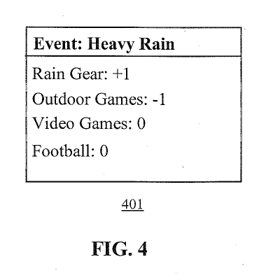

Using the statistical relationship between the occurrence of past events and their effect on sales of an item, mappings corresponding to past events may be generated and assigned to nodes in the item ontology tree 301. FIG. 4 shows a mapping table 401 for the occurrence of heavy rain in relation to the items in the item ontology tree 301 shown in FIG. 3. Positive, negative, and neutral numbers may be utilized in the table 401 to indicate the effect the event has on different categories and items in the ontology tree 301. The occurrence of certain events may increase the sales of certain items, decrease the sales of certain items, and have no effect on the sales of certain items. For example, a positive number (e.g., +1) may be used to indicate that the occurrence of an event has previously resulted in increased sales, a negative number (e.g., −1) may be used to indicate that the occurrence of an event has previously resulted in decreased sales, and a neutral number (e.g., 0) may be used to indicate that the occurrence of an event has not previously had any effect on sales. For example, referring to FIGS. 3 and 4, the statistical relation between the occurrence of heavy rain and the sales of the products in the ontology tree 301 indicates that when heavy rain occurs, there is an increase in sales of rain gear items, a decrease in sales of outdoor games, and no change in sales of video games and football items.

The statistical relationships may be linear or non-linear. For example, a linear relationship between past events and past sales of rain gear may be represented by Equation 1, and a non-linear relationship between past events and past sales of rain gear may be represented by Equation 2:

Sales(Rain Gear)=A*SNOW+B*RAIN+C*SPORTING_EVENT+D*OTHER_EVENTS+ Equation 1:

Probability(Sales of Rain Gear)=Logit (A*SNOW+B*RAIN+C*SPORTING EVENT+D*OTHER_EVENTS+ . . . ) Equation 2:

Similarly, a linear relationship between past actions and past sales may be represented by Equation 3, and a non-linear relationship between past actions and past sales of rain gear may be represented by Equation 4:

Sales(Rain Gear)=A*LOCAL_ADS+B*FLYERS+C*BUY1_GET1+D*OTHER_DISCOUNTS+ Equation 3:

Probability (Sales of Rain Gear)=Logit(A*LOCAL_ADS+B*FLYERS+C*BUY1_GET1+D*OTHER_DISCOUNTS+ . . . ) Equation 4:

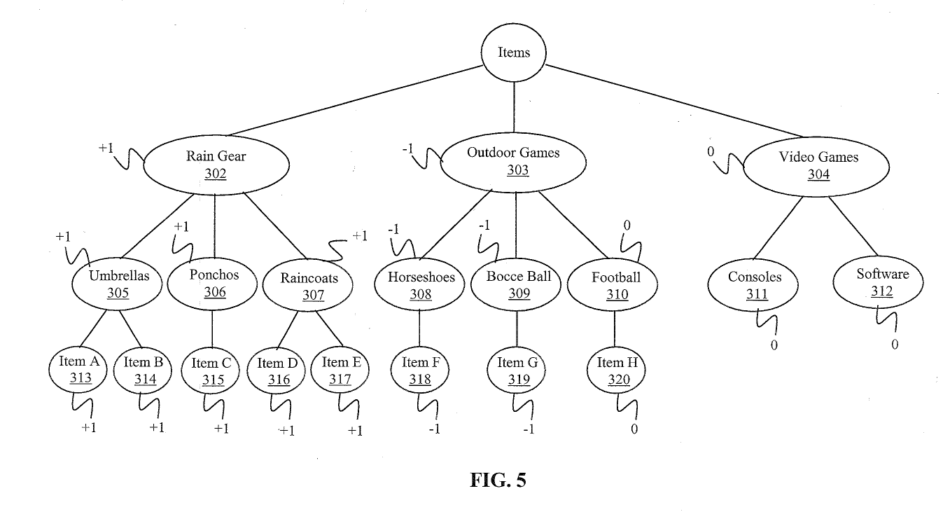

In Equations 1-4, A, B, C and D are parameters determined using regression methods, and logit is a logistic function defined as

$$logit ( x ) = \frac{1}{1 + {e}^{- x}} ,$$

wherein e is the exponential function. Mappings to a parent node apply to all subnodes of that parent node, unless a subnode is assigned its own specific mapping. For example, if a mapping is assigned to node 302, and no mappings are assigned to nodes 305, 306, and 307, the mapping assigned to node 302 is applied to nodes 305, 306, and 307. However, if one mapping is assigned to a parent node and another mapping is assigned to a subnode of the parent node, the mapping assigned to the subnode overrides the mapping assigned to the parent node. For example, if a mapping is assigned to node 303 and node 310, and no mappings are assigned to nodes 308 and 309, the mapping assigned to node 303 is applied to nodes 308 and 309, but not to node 310, since the mapping specifically assigned to node 310 overrides the mapping assigned to the parent node 303. FIG. 5 shows mappings assigned to the item ontology tree 301 shown in FIG. 3 based on the mapping table 401 shown in FIG. 4.

The calibration phase may result in a determination of a statistical relationship between the occurrence of events and their effects on sales, and a determination of a retailer's actions and their effects on sales. Once these determinations have been made, an event detection phase may be utilized to identify, in real-time, events of relevance to subscribed retailers. The event detection phase may utilize a variety of social networking sites such as, for example, FACEBOOK, TWITTER, or GOOGLE+, however, the present disclosure is not limited to these social networks. As will be appreciated by one having ordinary skill in the art, the present disclosure may be adapted to utilize any type of social network or website that includes data that may relate to the perception of a product.

The social network event detection-based analytics system 201 may establish an Internet connection via wires or wirelessly, and may interface with a social networking site via the network adapter 213 using, for example, a TCP/IP protocol. Once connected to a social networking site, a real-time social data stream output by the social networking site may be monitored by the system 201. The social data stream may include a large amount of unstructured data that is continuously updated in real-time, and may include data relating to, for example, user activity, user profiles, the number of friends of a user, or a user's particular friends. The social data stream may be exposed by the social networking site via a software interface (e.g., web services) that supports interoperable machine-to-machine interaction. Application code stored in one of the program modules 209 in the memory 203 of the social network event detection-based analytics system 201 may be utilized to monitor the real-time data stream output via the social networking site's interface, and data relating to product perception may be identified and extracted from the social data stream. The extracted data may then be utilized by the retailer. The data may include mentions of a specific product based on a keyword(s), mentions of related products based on a keyword(s), or mentions of related events based on a keyword(s). For example, if the social network event detection-based analytics system 201 is utilizing TWITTER, the system 201 may utilize the available interface to subscribe to tweets from specific users, which may then be analyzed by the system 201.

FIG. 6 is a flowchart illustrating the event detection phase, according to an exemplary embodiment. In the event detection phase, a list of keywords corresponding to given item sets is generated (block 601). The generated keyword lists are used when monitoring social networks and/or websites for relevant event information. For example, referring to FIG. 3, keyword lists are generated for rain gear, outdoor games, and video games (e.g., nodes 302-304). Keyword lists may also be generated for the subcategories and items within the rain gear, outdoor games, and video games categories (e.g., nodes 305-312). For example, using the name of a product, the names of various competing brands selling similar products may be extracted. In an exemplary embodiment, the keyword lists may include entries extracted from either a custom-built dictionary or websites via the Internet, or from both a custom-built dictionary and websites via the Internet. Each keyword may be assigned a weight, and a score may be generated based on the detected data and the weight of the corresponding keyword. This score may be used by the retailer when determining actions to take in response to an event.

Once the keyword lists are generated, seed users are filtered and collected from a social network based on the keyword lists (block 602). In addition to collecting the seed users, a certain number of the seed users' related users (e.g., friends or followers) or mentioned users are also collected. For example, in an exemplary embodiment, two levels of a seed user's related users may be collected along with the seed user. The seed users are filtered and collected for a predefined time period t. All messages sent and received by the collected seed users are continuously collected (block 603). While messages relating to the seed users are collected, messages sent by other users (e.g., non-seed users) in the social network may also be monitored and filtered based on the keyword lists (block 604). New users may be added as seed users based on these monitored messages (block 605). In addition, seed users for whom there is no activity for the last predefined time period t are removed from the collected seed users list (block 606). This results in an updated list of seed users that supplies a stream of relevant collected messages, as the list of seed users is expanded and reduced in real-time based on the quality of information.

Once a stream of relevant collected messages has been obtained, an event detection method may be performed on the stream. Event clusters may be generated based on a plurality of similarity measures. The plurality of similarity measures may include, for example, social measures (e.g., the number of friends or followers of a user, the type of relationship between the user and a friend or follower, etc.), spatial measures (e.g., the location of origin of the collected messages), temporal measures (e.g., the time of origin of the collected messages), and content of the collected messages.

For example, for each event cluster C_i, a similarity measure Sim(S_i, C_i) is computed. In an exemplary embodiment, the similarity measure Sim(S_i, C_i) may be determined using equation 5:

Sim(S_{—}i, C_{—}i)=a_{—}1.p(S_{—}i, C_{—}i)+a_{—}2.q(S_{—}i, C_{—}i)+a_{—}1.r(S_{—}i, C_{—}i) Equation 5:

In equation 5, p represents a social similarity measure, q represents content of the collected message, r represents the physical location corresponding to the messages, and the sum of a_1=1. The event detection method maintains a compact representation of a summary of event clusters using mean and standard deviation (SD). If Sim(S_i, C_x)>=mean−3.SD), S_i is added to a new cluster C_r and the least recently updated cluster is removed. If Sim(S_i, C_x)<mean−3.SD), S_i is added to C_x and the statistics of C_x are updated. The top K most frequent words that represent the cluster determines the event, and a summary statistics of cluster geolocations are returned.

The event detection method further maintains a cluster arrival count for a given unit of time, and stores this count using a compact histogram representation. Using the histogram, the mean and standard deviation for the number of arrivals may be computed, and this computation may be used to compute a z-score, where the P value (the probability calculated from cumulative standard normal distribution) is 0.95 or more.

For example, assume that a list of keywords includes a first reference to raincoat X having a weight of 1.0, a second reference to raincoat Y having a weight of 0.6, and a reference to “thunderstorm” having a weight of 0.5. Based on the extracted keywords and their corresponding weights, a combined score may be generated. A retailer may decide what actions to take based on the combined score. For example, if the combined score is greater than 0.8, the retailer may increase its stock of raincoat X. If the combined score is between 0.7 and 0.8, the retailer may give a discount on raincoat X. If the combined score is less than 0.7, the retailer may take no specific action.

In another example, analysis of sales history data and event history data shows that the occurrence of an outdoor rally and a possibility of rain increases the sales of raincoats and other weather related items. With this statistical relation known, the social network event detection-based analytics system 201 may monitor and filter messages collected from a set of users in one or more social networks for any reference to a rally. Once filtered, the system 201 may determine that the users referencing a rally are from a specific location, and an inference that a rally is occurring at the specific location may be made. The system 201 may also determine that a certain percentage of users are from an area other than the specific location. This information may be combined with weather information, which may be obtained, for example, from a weather website. The weight assigned to the weather information may vary depending on the likelihood of rain. For example, a higher weight may be assigned to the weather information when the probability of rain is 75% than when the probability of rain is 50%. Using these factors, the probability of the sale of raincoats and other weather related items may be calculated, and a combined score may be generated for raincoats and other weather related items. Each item may have a different combined score, and a retailer may take different actions for each of the items based on the respective scores. For example, if the combined score for a raincoat or weather related item is greater than 0.8, the retailer may increase its stock of the raincoat or weather related item. If the combined score is between 0.7 and 0.8, the retailer may give a discount on the raincoat or weather related item. If the combined score is less than 0.7, the retailer may take no specific action.

The flowcharts and block diagrams in the figures illustrate the architecture, functionality, and operation of possible implementations of systems, methods and computer program products according to various exemplary embodiments of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Having described exemplary embodiments for a system and method of informing sales strategies based on social network event detection-based analytics, it is noted that modifications and variations can be made by persons skilled in the art in light of the above teachings. It is therefore to be understood that changes may be made in exemplary embodiments of the disclosure, which are within the scope and spirit of the disclosure as defined by the appended claims. Having thus described exemplary embodiments of the disclosure with the details and particularity required by the patent laws, what is claimed and desired protected by Letters Patent is set forth in the appended claims.

What is claimed is:

1. A method of informing sales strategies using a social network, comprising:
receiving an input from an organization, wherein the input comprises information relating to an item for sale;
extracting sales data from a first database, event history data from a second database, and action history data from a third database, wherein the sales data represents past sales of the item, the event history data represents past events, and the action history data represents past actions taken by the organization;
establishing a connection with the social network via a communication network;
monitoring a real-time data stream via the connection to the social network for mentions relating to the item; and
generating an action recommendation relating to the item based on the sales data, the event history data, the action history data, and the mentions relating to the item.

2. The method of claim 1, wherein generating the action recommendation comprises:
determining an impact of the past events on the past sales of the item based on the sales data and the event history data;
determining an effectiveness of the past actions on the past sales of the item based on the sales data and the action history data; and
generating the action recommendation based on the determined impact of the past events on the past sales, and the determined effectiveness of the past actions on the past sales.

3. The method of claim 1, wherein the action recommendation comprises at least one of changing a price of the item, adjusting advertisements for the item, offering a promotion for the item, or adjusting a location of the item in a store.

4. The method of claim 1, wherein the mentions relating to the item comprise current event information corresponding to an ongoing event or an upcoming event.

5. The method of claim 4, further comprising:
determining a duration of an event corresponding to the current event information, wherein the duration comprises an identified start time of the event and a probable end time of the event.

6. The method of claim 5, wherein generating the action recommendation is based on the duration of the event.

7. The method of claim 4, wherein the current event information comprises a plurality of keywords.

8. The method of claim 7, further comprising:
assigning a weight value to each of the plurality of keywords;
generating a score corresponding to the item based on the weighted keywords; and
generating the action recommendation relating to the item based on the score.

9. The method of claim 1, wherein the input received from the organization comprises at least one of an item parameter or an organization characteristic parameter.

10. The method of claim 9, wherein the item parameter comprises at least one of an item type, an item use, an item price, or an intended demographic of the item.

11. The method of claim 9, wherein the organization characteristic parameter comprises at least one of a location of the organization, an organization type, or hours of operation corresponding to the organization.

12. The method of claim 1, wherein the organization is one of a retailer, a wholesaler, or a manufacturer.

13. The method of claim 1, wherein the input received from the organization comprises a plurality of items for sale, and the plurality of items are classified using an ontology tree.

14. The method of claim 13, wherein the plurality of items are classified in the ontology tree based on parameters of the items.

15. The method of claim 13, further comprising assigning a value of +1, 0, or −1 to nodes in the ontology tree based on the sales data and the event history data, wherein a value of +1 indicates a potential for increased sales in response to an event, a value of −1 indicates a potential for decreased sales in response to the event, and a value of 0 indicates a potential for no change in sales in response to the event.

16. The method of claim 15, wherein a value assigned to a node in the ontology tree is automatically applied to subnodes of the node.

17. The method of claim 1, wherein the mentions relating to the item comprise a plurality of keywords relating to the item.

18. The method of claim 17, further comprising:
assigning a weight value to each of the plurality of keywords;
generating a score corresponding to the item based on the weighted keywords; and
generating the action recommendation relating to the item based on the score.

19. The method of claim 1, further comprising:
establishing a connection with an Internet website via the communication network;
extracting data from the Internet website; and
generating the action recommendation relating to the item based on the extracted data.

20. The method of claim 19, wherein the extracted data comprises weather information.

21. A method of generating a stream of data related to an item set from a social network, comprising:
generating a plurality of keywords relating to the item set;
establishing a connection with a social network via a communication network;
generating a list of seed users from the social network based on the plurality of keywords;
generating a list of secondary users related to the seed users;
monitoring messages sent from and received by the seed users and the secondary users;
extracting messages from the monitored messages, wherein the extracted messages include at least one of the plurality of keywords; and
generating the stream of data related to the item based on the extracted messages.

22. The method of claim 21, further comprising:
removing a seed user from the list of seed users upon determining that the seed user has not sent or received a message for a predetermined time period; and
removing a secondary users from the list of secondary users upon determining that the secondary user has not sent or received a message for the predetermined time period.

23. The method of claim 21, further comprising removing a secondary user from the list of secondary users, and adding the secondary user to the list of seed users upon the secondary user sending or receiving a message including at least one of the plurality of keywords.

24. A system for informing sales strategies using a social network, comprising:
a network adapter configured to establish a connection to a social network and an organization via a communication network, and receive input from the organization comprising information relating to an item for sale;
a first database comprising sales data representing past sales of an item;
a second database comprising event history data representing past events;
a third database comprising action history data representing past actions taken by the organization; and
a processor configured to monitor a real-time data stream via the connection to the social network for mentions relating to the item, and generate an action recommendation relating to the item based on the sales data, the event history data, the action history data, and the mentions relating to the item.

25. The system of claim 24, wherein the processor is further configured to determine an impact of the past events on the past sales of the item based on the sales data and the event history data, determine an effectiveness of the past actions on the past sales of the item based on the sales data and the action history data, and generate the action recommendation based on the determined impact of the past events on the past sales, and the determined effectiveness of the past actions on the past sales.
